(19) United States
(12) Patent Application Publication
(10) Pub. No.: US 2026/0312934 A1
(43) Pub. Date: Oct. 8, 2026

(54) INLINE MULTI-STAGE ATTACK DETECTION AND PREVENTION

(71) Applicant: Palo Alto Networks, Inc., Santa Clara, CA (US)

(72) Inventors: Zhibin Zhang, Santa Clara, CA (US); Christian Elihu Navarrete Discua, San Jose, CA (US); Haozhe Zhang, San Jose, CA (US); Yiheng An, San Jose, CA (US)

(21) Appl. No.: 19/173,118

(22) Filed: Apr. 8, 2025

(51) Int. Cl. H04L 9/40

(52) U.S. Cl. CPC H04L 63/0236; H04L 63/1425; H04L 63/1466

(57) ABSTRACT

A firewall is configured with a rule(s) for filtering network traffic that, if matched, triggers forwarding of the network traffic to a multi-stage attack detector. The detector extracts designated data/metadata therefrom and stores the data/metadata in association with a unique identifier. Assuming a benign verdict for the first communication, the detector returns to the firewall the benign verdict and a temporary forwarding rule that specifies network traffic characteristics indicative of a potential multi-stage attack in subsequent communications and includes the unique identifier. The firewall forwards network traffic that matches the temporary forwarding rule and an indication of the identifier to the detector, which correlates data/metadata extracted from the network traffic with the previously extracted data/metadata associated with the identifier and evaluates the correlated data/metadata based on a multi-stage attack detection rule(s). If the correlated data/metadata satisfy a detection rule, the detector returns a malicious verdict to the firewall.

### BACKGROUND

The disclosure generally relates to network architectures or network communication protocols for network security (e.g., CPC subclass H04L 63/00) and to security arrangements for protecting computers, components thereof, programs or data against unauthorized activity (e.g., CPC subclass G06F 21/00).

Multi-stage attacks refer to cyberattacks that are carried out over a series of stages, or a series of communication exchanges. Signature-based and machine-learning based attack detection techniques generally analyze network traffic corresponding to a single stage. By breaking the attack into stages, adversaries can evade detection techniques for single-stage attacks, making detection and mitigation of such attacks more challenging.

### BRIEF DESCRIPTION OF THE DRAWINGS

Embodiments of the disclosure may be better understood by referencing the accompanying drawings.

FIG. 1 is a conceptual diagram of detecting and managing an initial stage of a potential multi-stage attack through network traffic characteristic extraction and temporary forwarding rule configuration.

FIG. 2 is a conceptual diagram of detecting a multi-stage attack based on correlation of network traffic characteristics.

FIG. 3 is a flowchart of example operations for performing inline detection of multi-stage attacks.

FIG. 4 is a flowchart of example operations for evaluating network traffic filtered by a cybersecurity appliance for multi-stage attack detection.

FIG. 5 is a flowchart of example operations for correlating network traffic with previously detected network traffic for multi-stage attack detection.

FIG. 6 depicts an example computer system with a traffic filter and a multi-stage attack detector.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

This description uses the phrase “multi-stage attack” to refer to an attack carried out over a series of communications (e.g., a series of requests). A “stage” of a multi-stage attack is a single communication between a source and destination (e.g., a single request). Stages of the multi-stage attack can correspond to different sessions and/or protocols. In other words, the series of communications via which a multi-stage attack is carried out are not necessarily consecutive with respect to a single session.

This description uses shorthand terms related to cloud technology for efficiency and ease of explanation. When referring to “a cloud,” this description is referring to the resources of a cloud service provider. For instance, a cloud can encompass the servers, virtual machines, and storage devices of a cloud service provider. In more general terms, a cloud service provider resource accessible to customers is a resource owned/managed by the cloud service provider entity that is accessible via network connections. Often, the access is in accordance with an application programming interface (API) or software development kit provided by the cloud service provider.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Disclosed herein are techniques for inline detection of multi-stage attacks, such as Server-Side Request Forgery (SSRF), Remote File Inclusion (RFI), command injection, and out-of-band Extensible Markup Language (XML) external entity (XXE) attacks, based on network traffic correlation and analysis. A cybersecurity appliance (e.g., a firewall) is configured with one or more rules for filtering network traffic that, if matched, trigger forwarding of the matching network traffic to a multi-stage attack detector for further analysis. The attack detector, which can execute as a cloud-based service, receives the detected network traffic, extracts one or more network traffic characteristics from the network traffic (e.g., a network address, indication of a resource, etc.), and stores the extracted network traffic characteristics in association with a unique identifier. Assuming a benign verdict for the first network traffic forwarded to the attack detector, as the initially filtered network traffic corresponding to a multi-stage attack likely will not trigger a malicious verdict, the attack detector returns the benign verdict and a temporary forwarding rule comprising the unique identifier to the cybersecurity appliance for installation thereto. The temporary forwarding rule specifies network traffic characteristics determined based on those that the attack detector extracted that may be indicative of a multi-stage attack in subsequently detected communications.

Upon detection of network traffic that matches the temporary forwarding rule, the cybersecurity appliance forwards the network traffic and the unique identifier associated with the temporary forwarding rule to the attack detector. The attack detector correlates network traffic characteristics extracted from the network traffic with the previously extracted network traffic characteristics associated with that identifier. The correlated network traffic characteristics can correspond to different sessions and/or protocols but can be correlated due to their common association with the assigned identifier. The attack detector then evaluates the correlated network traffic characteristics based on one or more multi-stage attack detection rules, which comprise rules for detecting attacks carried out over multiple stages. If a multi-stage attack detection rule is satisfied by the correlated network traffic characteristics, the attack detector returns a malicious verdict to the cybersecurity appliance, based on which the cybersecurity appliance can take action to block the network traffic and perform any remediation. As a result, the multi-stage attack is blocked.

### Example Illustrations

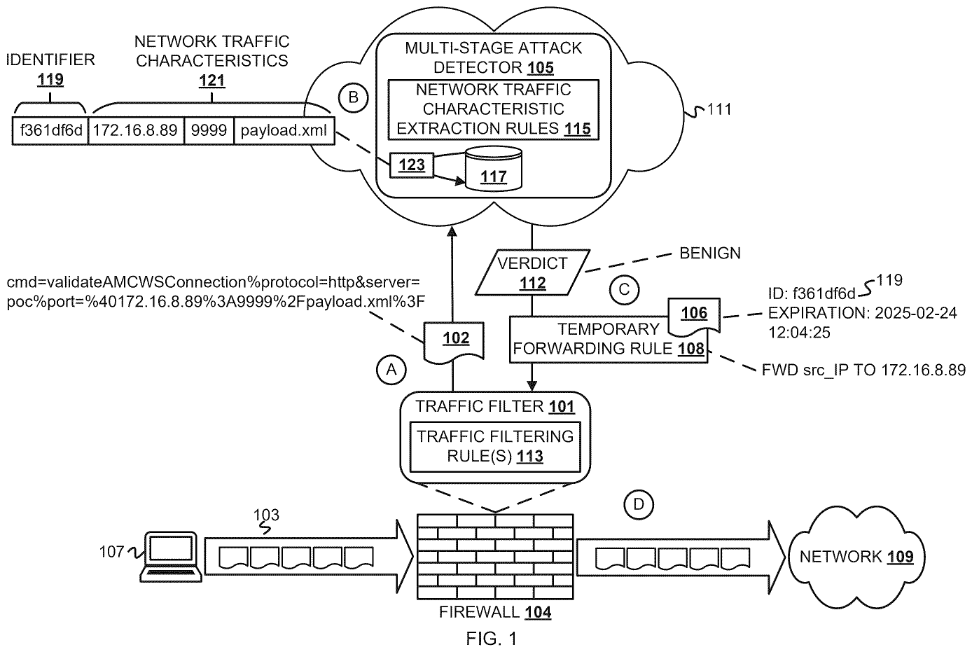

FIG. 1 is a conceptual diagram of detecting and managing an initial stage of a potential multi-stage attack through network traffic characteristic extraction and temporary forwarding rule configuration. A firewall 104 secures a network 109. The firewall 104 may be a cloud-based firewall, a virtual firewall, or a physical firewall deployed to inspect network traffic sent to and from the network 109. FIG. 1 depicts a client 107 assumed to be connected to the network 109 and for which the firewall 104 intercepts and inspects inbound and outbound network traffic. FIG. 1 also depicts a multi-stage attack detector (“detector”) 105. The detector 105 detects multi-stage attacks, which can correspond multiple sessions and/or protocols, based on correlation of extracted network traffic characteristics across multiple detected communications. The detector 105 in this example executes in a cloud 111 as a cloud-based service that communicates with the firewall 104. In other examples, the detector 105 can execute as a service of the firewall 104.

A traffic filter 101 executes on the firewall 104. The traffic filter 101 identifies network traffic or data included therein (e.g., data identified in network traffic payloads) that should be filtered out and forwarded to the detector 105 for further analysis. The traffic filter 101 has been configured with traffic filtering rules (“rule(s)”) 113 that, if satisfied, trigger forwarding of the network traffic or portion thereof that satisfies the rule(s) 113 to the detector 105. For instance, the rule(s) 113 can comprise one or more patterns, such as regular expressions, for detecting suspicious network traffic that should be subject to further analysis.

FIG. 1 is annotated with a series of letters A-D. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the traffic filter 101 filters network traffic originating from the client 107 based on the rule(s) 113. The firewall 104 detects network traffic 103 that comprises a payload 102 that includes a first command, depicted in this example as “cmd=validateAMCWSConnection%protocol=http&server=poc%port=%40172.16.8.89%3A9999%2Fpayload.xml%3F”. The traffic filter 101 evaluates the network traffic 103 based on the rule(s) 113 and determines that the payload 102 satisfies the rule(s) 113. For instance, the rule(s) 113 can comprise a pattern to which suspicious payloads are matched, where the suspicious payloads comprise an Internet Protocol (IP) address, a port, and/or an indication of a file or uniform resource locator (URL). The traffic filter 101 extracts (e.g., copies) the payload 102 from the network traffic 103 and forwards the payload 102 to the detector 105, though implementations can forward network traffic without extraction (e.g., Hypertext Transfer Protocol (HTTP) messages comprising a header and body) to the detector 105. While the detector 105 evaluates the payload 102, the firewall 104 holds that of the network traffic 103 from which the payload 102 was extracted.

At stage B, the detector 105 evaluates the payload 102 based on network traffic characteristic extraction rules (“rules”) 115. The rules 115 comprise rules for extracting network traffic characteristics from network traffic or portions thereof (e.g., payloads) forwarded by the traffic filter 101. For instance, the rule(s) 115 can comprise one or more patterns and/or one or more keywords (e.g., one or more header fields) specifying network traffic characteristics to be extracted from network traffic. As an example, the rule(s) 115 can comprise one or more patterns for detecting IP addresses, ports, and files or URLs in network traffic payloads. This example assumes that the detector 105 extracts network traffic characteristics 121 comprising the IP address “172.16.8.89”, the port number “9999”, and the file name “payload.xml” from the payload 102. Further, the rule(s) 115 can be associated with identifiers indicating types of attacks for which subsequent network traffic will be monitored based on extraction of network traffic characteristic from detected traffic. This example assumes that the network traffic characteristics 121 were extracted based on matching a rule defined for SSRF attack detection.

The detector 105 assigns an identifier 119 to the network traffic characteristics 121. The identifier 119 is unique across any previously assigned identifiers to extracted network characteristics (e.g., may be a universally unique identifier (UUID)) and facilitates tracking of subsequent communications to the entity indicated in the network traffic characteristics 121, such as subsequent requests to access the file “payload.xml”. This example depicts the identifier 119 as having the value “f361df6d”. The detector 105 updates a data store 117 of network traffic characteristics with an entry 123 comprising the identifier 119 and the network traffic characteristics 121 extracted from the payload 102. The data store 117 can be a cache, database, etc. that stores associations between unique identifiers assigned to extracted network traffic characteristics and the network traffic characteristics. Subsequent lookups in the data store 117 with the identifier 119 will return the network traffic characteristics 121 as a result.

At stage C, the detector 105 communicates a benign verdict 112 and a temporary forwarding rule 108 to the firewall 104. The detector 105 generates a benign verdict 112 because the network traffic characteristics 121 were the first associated with the identifier 119 (i.e., the identifier 119 was newly assigned as part of evaluating the payload 102). The detector 105 also configures a temporary forwarding rule 108. The temporary forwarding rule 108 specifies forwarding of any detected network traffic destined for the IP address “172.16.8.89” indicated in the payload 102 to the detector 105 for determination of whether the detected network traffic may be part of a multi-stage attack initialed via the network traffic 103. The temporary forwarding rule 108 comprises metadata 106 indicating an expiration date and time of the temporary forwarding rule 108, an identifier indicating an attack type for which network traffic is being monitored (which is an SSRF attack in this example), and the identifier 119. The expiration date and time of the metadata 106 indicate a time at which the temporary forwarding rule 108 will be deactivated/will expire and can be defaulted to a brief time period following detection of the network traffic 103 (e.g., can set an expiration time of 5 minutes out). The detector 105 can determine the identifier indicating the attack type to include in the metadata 106 based on which of the rule(s) 115 were leveraged for extraction of network traffic characteristics. The metadata 106 also indicate the identifier 119 so that any network traffic that triggers the temporary forwarding rule 108 can be associated with the identifier 119 when it is forwarded to the detector 105.

At stage D, the firewall 104 forwards the network traffic 103 to its destination over the network 109. Because the payload 102 received a benign verdict by the detector 105, assuming that the network traffic 103 is allowed by any other security policies of the firewall 104, the firewall 104 allows the corresponding network traffic 103 and forwards the network traffic 103 toward its destination.

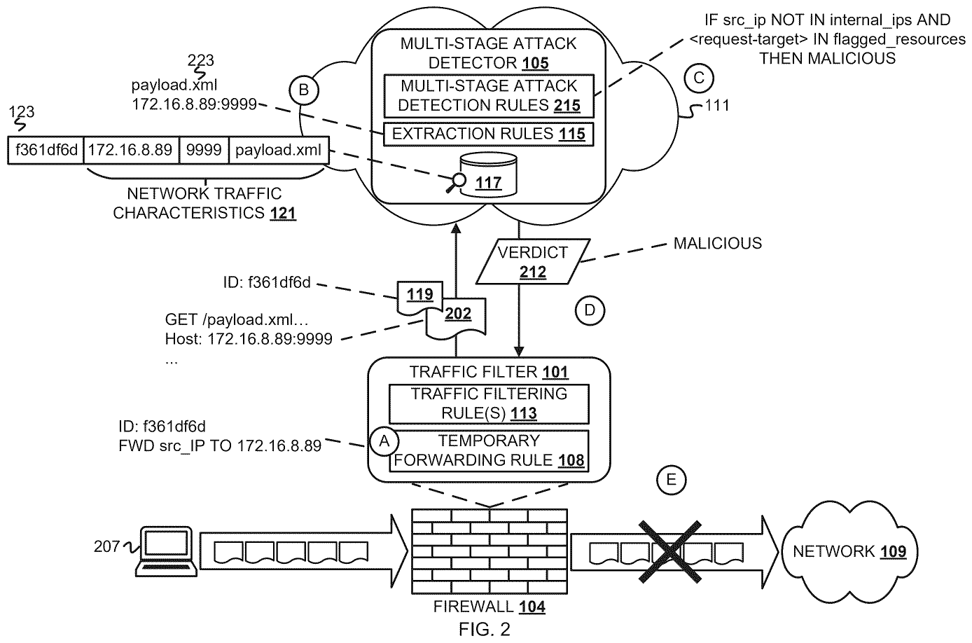

FIG. 2 is a conceptual diagram of detecting a multi-stage attack based on correlation of network traffic characteristics. FIG. 2 depicts the traffic filter 101 as having the temporary forwarding rule 108 installed. The data store 117 also comprises the entry 123 that includes the network traffic characteristics 121 extracted as described in reference to FIG. 1 and associated with the identifier 119 that was also included as metadata of the temporary forwarding rule 108. In this example, the firewall 104 inspects network traffic sent to and from a client 207 that differs from the client 107 of FIG. 1 to illustrate that multi-stage attacks can be carried out over multiple sessions corresponding to different clients rather than a single session corresponding to a single client.

FIG. 2 is annotated with a series of letters A-E. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the traffic filter 101 forwards network traffic originating from the client 207 to the detector 105 based on the temporary forwarding rule 108 (which is assumed to be active/non-expired in this example). The firewall 104 detects a HTTP GET request 202 for the resource “payload.xml” originating from the host “172.16.8.89:999”. The traffic filter 101 determines that the request 202 matches the temporary forwarding rule 108 since the request 202 is destined for the IP address “172.16.8.89” that is indicated in the temporary forwarding rule 108. The traffic filter 101 forwards a copy of the request 202 to the detector 105. With the copy of the request 202, the traffic filter 101 includes the identifier 119 associated with the temporary forwarding rule 108 as metadata. The traffic filter 101 may also include an identifier indicating the attack type included in the temporary forwarding rule 108 with the copy of the request 202, which is the identifier “SSRF” in this example.

At stage B, the detector 105 correlates network traffic characteristics extracted from the request 202 with previously extracted network traffic characteristics also associated with the identifier 119. The detector 105 extracts network traffic characteristics from the request 202 based on the rule(s) 115 as similarly described in reference to FIG. 1. In this example, the detector 105 extracts network traffic characteristics 223 comprising the file name “payload.xml” and host IP address/port “172.16.8.89:9999” from the request 202. To correlate the network traffic characteristics 223 with the previously extracted network traffic characteristics associated with the identifier 119, or the network traffic characteristics 121, the detector performs a lookup in the data store 117 with the identifier 119 for network traffic characteristics previously extracted and associated with the identifier 119. The lookup returns the entry 123 comprising the network traffic characteristics 121 indicating the IP address “172.16.8.89”, port number “9999”, and file name “payload.xml”.

At stage C, the detector 105 evaluates the network traffic characteristics associated with the identifier 119, which includes the network traffic characteristics 121 and the network traffic characteristics 223, based on multi-stage attack detection rules (“detection rules”) 215. Examples of multi-stage attacks for which a detection rule is defined in the detection rules 215 include SSRF attacks, RFI attacks, command injection, and XXE attacks. The detection rules 215 in this example comprise a first rule for detecting attempted SSRF attacks. The detector 105 determines that the network traffic characteristics 121, 223 associated with the identifier 119 were extracted for monitoring of SSRF attacks due to the inclusion of the attack detection type identifier “SSRF” in the temporary forwarding rule 108 (which may have been communicated with the copy of the request 202, associated with the network traffic characteristics 121 in the data store 117, etc.), so the detector 105 evaluates the network traffic characteristics 121, 223 based on the rule defined for SSRF attack detection. This rule indicates that if the source IP address of detected network traffic originates externally (i.e., does not correspond to a trusted, internal IP address) and the request target is a flagged resource, the network traffic is malicious. A resource can be considered flagged if its name, identifier, etc. is indicated in the data store 117 and thus was extracted from previously detected network traffic. An IP address extracted from a network traffic payload (i.e., as opposed to a header field for IP addresses) as was the IP address “172.16.8.89:9999” often will not be a trusted, internal IP address, which is assumed to be the case in this example. The detector 105 also determines that the resource “payload.xml” was previously flagged as a result of being stored in the data store 117 in association with the IP address and port “172.16.8.89:9999”. As a result, the detector 105 determines that the correlated network traffic characteristics associated with the identifier 119 (i.e., the network traffic characteristics 121, 223) satisfy this one of the detection rules 215 and thus potentially correspond to an attempted SSRF attack.

At stage D, the detector 105 communicates a malicious verdict 212 to the firewall 104. The detector 105 generates the malicious verdict 212 as a result of determining that one of the detection rules 215 was satisfied (namely, the rule for detecting SSRF attacks) and communicates the malicious verdict 212 to the firewall 104.

At stage E, the firewall 104 blocks communication of the request 202 over the network 109. Because the detector 105 detected a multi-stage attack based on the request 202, the firewall 104 blocks the request 202 to prevent completion of the attack.

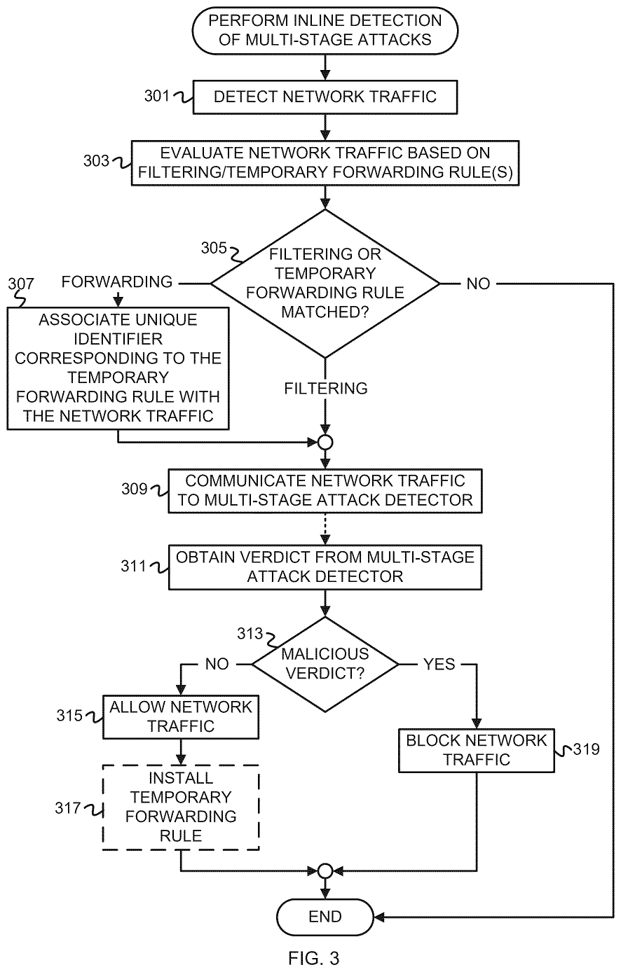

FIGS. 3-5 are flowcharts of example operations. The example operations are described with reference to a traffic filter and a multi-stage attack detector (hereinafter “the detector”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for performing inline detection of multi-stage attacks. The example operations are described with respect to the traffic filter. The traffic filter executes as part of a cybersecurity appliance and communicates with the detector.

At block 301, the traffic filter detects network traffic. The traffic filter can detect network traffic corresponding to a variety of protocols (e.g., HTTP/HTTP Secure (HTTPS), Transmission Control Protocol (TCP), etc.).

At block 303, the traffic filter evaluates the detected network traffic based on a filtering rule(s) and/or a temporary forwarding rule(s). The filtering rule(s) is a rule(s) with which the traffic filter is configured for filtering out potentially suspicious network traffic that should be forwarded to the detector for further evaluation. For instance, the filtering rule(s) can be implemented with a pattern(s) (e.g., a regular expression) for detecting network traffic that includes network socket and/or application information in the payload. To illustrate, the traffic filter may be configured with a regular expression or other pattern that matches HTTP requests that include an IP address in the request body. The traffic filter may also have installed one or more temporary forwarding rules configured by the detector based on previously detected network traffic for identifying network traffic that should be evaluated further for the presence of a multi-stage attack. A temporary forwarding rule is associated with metadata indicating an expiration time of the rule. If the traffic filter has installed any such temporary forwarding rules that are active (i.e., non-expired), the traffic filter also evaluates the network traffic based on the temporary forwarding rule(s).

At block 305, the detector determines if a filtering or temporary forwarding rule was matched by the network traffic. If the network traffic matches a temporary forwarding rule, operations continue at block 307. If the network traffic matches a filtering rule, operations continue at block 303. If the network traffic does not match any rules, operations are complete, and the network traffic may be allowed to pass assuming that it satisfies a security policy(ies) of the cybersecurity appliance.

At block 307, the traffic filter associates a unique identifier corresponding to the temporary forwarding rule with the network traffic. The temporary forwarding rule also comprises metadata indicating a unique identifier assigned thereto at the time of its configuration. The traffic filter associates the unique identifier with the network traffic (e.g., by labelling, tagging, etc. the network traffic).

At block 309, the traffic filter communicates (e.g., forwards) the network traffic to the detector. The traffic filter may have established a secure communication channel with the detector, can invoke the detector (e.g., via an API of the detector), etc. The traffic filter can copy the network traffic or a portion thereof, forward the copy to the detector, and hold the network traffic at the cybersecurity appliance while the detector performs its evaluation. For instance, the traffic filter can extract the payload from the network traffic and forward the payload to the detector. The transition between block 309 and block 311 is depicted with a dashed line to indicate that operations proceed when the traffic filter obtains a response from the detector.

At block 311, the traffic filter obtains a verdict from the detector. The verdict indicates if the detector predicted the network traffic to be benign, which may be indicative that the detector does not have enough information to form a malicious verdict, or malicious.

At block 313, the traffic filter determines if the detector indicated a malicious verdict. If the detector did not indicate a malicious verdict (i.e., the verdict was benign), operations continue at block 315. If the detector indicated a malicious verdict, operations continue at block 319.

At block 315, the traffic filter allows the network traffic. The traffic filter allows the network traffic to pass towards its destination.

At block 317, the traffic filter installs a temporary forwarding rule. The detector may have provided a temporary forwarding rule configured based on the network traffic with the verdict. For instance, the temporary forwarding rule may indicate that any network traffic destined for the same IP address from which the network traffic detected at block 301 originated that is detected within a designated time period/before an expiration time (e.g., within the next three seconds) should be forwarded to the detector. Block 317 is depicted with dashed lines to indicate that installation of a temporary forwarding rule is optional and dependent on whether the detector provided a rule to install, as the detector may not provide a temporary forwarding rule with each benign verdict. Generally, the detector will configure a temporary forwarding rule and indicate the temporary forwarding rule to the traffic filter at least based on detecting a potential first stage (i.e., a first detected communication) of a multi-stage attack.

At block 319, the traffic filter blocks the network traffic. If the detector indicated a malicious verdict for the network traffic, the network traffic was predicted to correspond to a multi-stage attack. The traffic filter blocks the network traffic to prevent completion of the multi-stage attack.

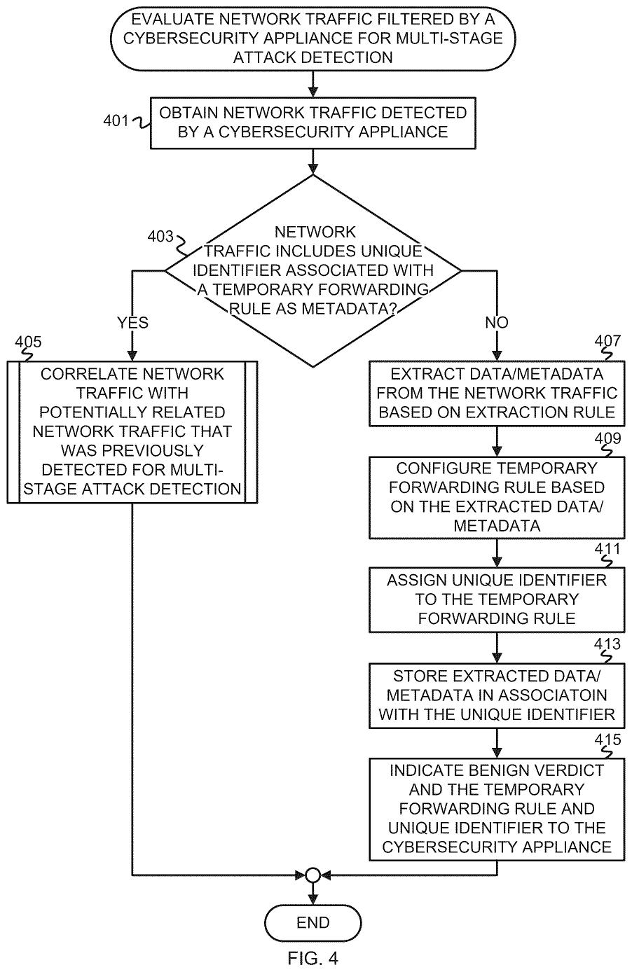

FIG. 4 is a flowchart of example operations for evaluating network traffic filtered by a cybersecurity appliance for multi-stage attack detection. The example operations assume that the detector has obtained network traffic (or a portion thereof, such as an extracted payload) detected by a cybersecurity appliance that matched a filtering rule or a temporary forwarding rule as described in reference to FIG. 3.

At block 401, the detector obtains network traffic detected by a cybersecurity appliance. The network traffic can comprise a protocol data units (PDUs) detected by the cybersecurity appliance and forwarded to the detector, such as an HTTP message, a packet, a TCP segment, etc. Alternatively, the network traffic can comprise a payload extracted from detected network traffic.

At block 403, the detector determines if the network traffic includes a unique identifier associated with a temporary forwarding rule as metadata. The cybersecurity appliance may have installed one or more temporary forwarding rules configured by the detector, where each temporary forwarding rule is associated with a unique identifier that the traffic filter attaches to network traffic (i.e., as metadata) that matches the forwarding rule. If the network traffic includes such a unique identifier, operations continue at block 405. If not, the network traffic may be associated with a first stage of a potential attack (i.e., related network traffic corresponding to a previous stage of an attack has not yet been detected), and operations continue at block 407.

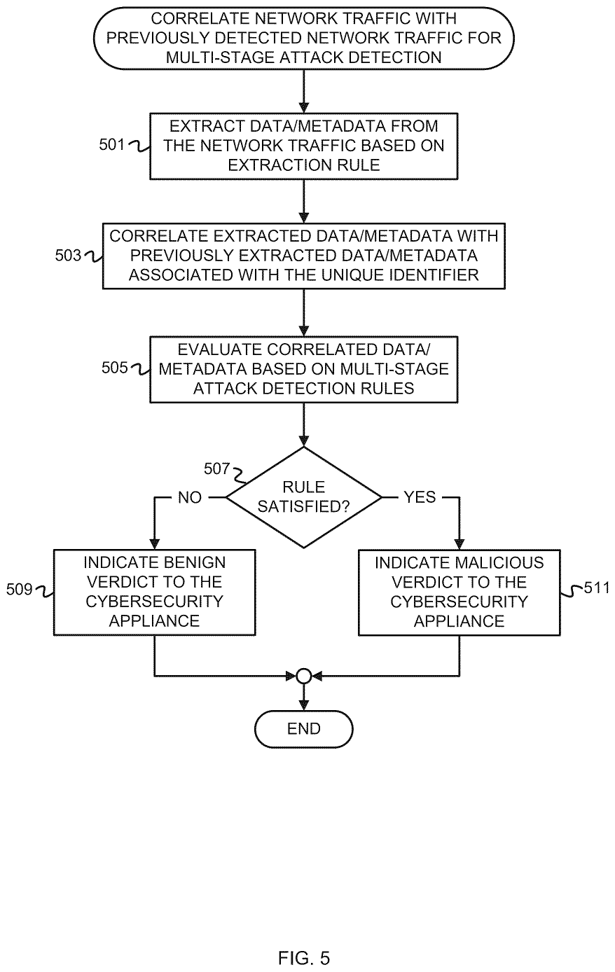

At block 405, the detector correlates the network traffic with potentially related network traffic that was previously detected for multi-stage attack detection. The detector performs a lookup in maintained associations between unique identifiers and data/metadata extracted from previously detected network traffic to retrieve data/metadata extracted from network traffic that is potentially related to that obtained at block 401. The detector evaluates the extracted data/metadata that is correlated via association with the unique identifier based on multi-stage attack detection rules to determine if the correlated data/metadata is indicative of an attack being carried out over multiple communications. Correlation of network traffic for multi-stage attack detection is described in further detail in reference to FIG. 5.

At block 407, the detector extracts data and/or metadata from the network traffic based on one or more extraction rules. The extraction rule(s) indicates one or more network traffic fields from which to extract a respective value and/or one or more patterns. The field(s) and/or pattern(s) can correspond to different network traffic protocols. For instance, the extraction rule(s) can indicate a field and/or pattern corresponding to HTTP traffic and a field and/or pattern corresponding to TCP traffic. Example fields include HTTP header fields, such as fields indicating a host (e.g., an IP address) and an application (e.g., an HTTP User Agent header field). Example patterns include patterns for detecting IP addresses, ports, and/or resource indications (e.g., URLs, file names, etc.) in network traffic payloads. Different patterns can be implemented for different attack detection types. As an illustrative example, the detector can be configured with the regular expression “([\w.−]+) (?::(\d+))?/[\w/]*\.xml” that matches URL-decoded payloads that indicate XML files at remote network addresses.

At block 409, the detector configures a temporary forwarding rule based on the extracted data and/or metadata. The temporary forwarding rule specifies that network traffic matching the rule should be forwarded to the detector during a configured time period. The temporary forwarding rule indicates at least a subset of the data and/or metadata such that network traffic that comprises that data/metadata is identified to match the rule and triggers forwarding of the network traffic to the detector. As an example, the temporary forwarding rule can indicate that network traffic destined for an IP address that was extracted from the network traffic should trigger the forwarding rule. Network traffic that indicates the IP address (e.g., in the “Host” field of an HTTP header) thus matches the rule and is forwarded to the detector. The time period during which the temporary forwarding rule is active is given by an expiration date/time indicated in metadata of the rule. The expiration date/time can be selected based on a time length with which the detector has been configured. For instance, for a time length of three seconds, the detector configures the temporary forwarding rule with an expiration date/time three seconds from the current time. The detector can also include in the temporary forwarding rule an identifier corresponding to a type of attack for which network traffic will subsequently be monitored via the rule. The identifier corresponding to the attack type can be determined based on the data/metadata extraction rule that was satisfied at block 407. As an illustrative example, a temporary forwarding rule defined for SSRF attack monitoring based on extraction of the IP address “172.16.8.89” and port number “9999” from network traffic can be defined as “TmpFwdRule<id=613471ef-000e-49b6-8764-dae6357186d4, detection=ssrf, stage=1, src_ip=3232235522, src_port=59649, dst_ip=172.16.8.89, dst_port=9999, app=, timeout=5>”.

At block 411, the detector assigns a unique identifier to the temporary forwarding rule. The unique identifier is unique across temporary forwarding rules that the detector has configured. For instance, the detector can assign a UUID to the temporary forwarding rule. The identifier is associated with the temporary forwarding rule as metadata.

At block 413, the detector stores the extracted data and/or metadata in association with the unique identifier. The detector stores the extracted data and/or metadata in association with the unique identifier in a cache, in a data structure(s), in a database, etc. such that subsequent lookups with the unique identifier will return the data and/or metadata. Implementations may also store the attack type identifier associated with the temporary forwarding rule in association with the extracted data and/or metadata.

At block 415, the detector indicates the benign verdict and the temporary forwarding rule with the unique identifier to the cybersecurity appliance. The detector provides the benign verdict and temporary forwarding rule having the unique identifier associated therewith to the cybersecurity appliance. Network traffic that is subsequently matched to the temporary forwarding rule at the cybersecurity appliance will thus be forwarded to the detector in association with the unique identifier.

FIG. 5 is a flowchart of example operations for correlating network traffic with previously detected network traffic for multi-stage attack detection. The example operations assume that the network traffic was communicated to the detector in association with a unique identifier (e.g., as described in reference to FIG. 4).

At block 501, the detector extracts data and/or metadata from the network traffic based on an extraction rule. The detector is configured with one or more extraction rules for extracting data and/or metadata from detected network traffic. Each extraction rule can be implemented as a pattern (e.g., a regular expression) or can include an indication of a network traffic field(s) (e.g., a metadata field) from which to extract the corresponding value. Example extraction rules include extraction rules for identifying an IP address, a port, an application (e.g., a User-Agent), etc. in detected network traffic, such as in a payload extracted from detected network traffic. The rules can comprise different rules for different potential attack stages.

At block 503, the detector correlates the extracted data and/or metadata with previously extracted data and/or metadata associated with the unique identifier. The detector determines the unique identifier associated with the network traffic and performs a lookup in maintained associations between unique identifiers and previously extracted data and/or metadata. The maintained associations can be implemented with a cache, a data structure(s), a database maintained by or made accessible to the detector, etc. A result of the lookup should comprise the previously extracted data and/or metadata associated with that unique identifier, which corresponds to one or more previous stages of communication being monitored for a multi-stage attack.

At block 505, the detector evaluates the correlated data and/or metadata based on one or more multi-stage attack detection rules. The multi-stage attack detection rules comprise rules for detection of multi-stage attacks based on a series of related communications that have been detected and from which data and/or metadata have been extracted. Communications are related in their common association with a unique identifier assigned by the detector to the data/metadata extracted from a first stage of network traffic and to the temporary forwarding rule that triggered forwarding of the network traffic to the detector. A rule for detecting a multi-stage attack can comprise multiple criteria that correspond to multiple respective stages of communication and/or can comprise criteria for multiple protocols (e.g., criteria for both TCP and HTTP traffic). An example of a multi-stage attack detection rule for SSRF detection is a rule that triggers attack detection when network traffic originating from a previously-flagged IP address that comprises a request for a flagged resource (e.g., a flagged URL, file, etc.), where the previously-flagged IP address and resource have been extracted from previously detected network traffic forwarded to the detector as being suspicious and/or a rule that triggers attack detection when network traffic detected for a second stage comprises a sensitive value of the User-Agent field. To illustrate, the detector can determine if the extracted data/metadata for the network traffic comprise a source IP address and indication of a resource that were previously associated with the unique identifier and identified as a result of the correlation at block 503. Examples of other multi-stage attacks for which detection rules can be configured include RFI attacks, command injection attacks, out-of-band Extensible Markup Language (XML) external entity attacks, and malware download events.

At block 507, the detector determines if a multi-turn attack detection rule was satisfied. If the correlated data and/or metadata did not satisfy a rule, operations continue at block 509. If the correlated data and/or metadata satisfied a rule, operations continue at block 511.

At block 509, the detector indicates a benign verdict to the cybersecurity appliance. While the stages of communication associated with the correlated data/metadata may have yielded a benign verdict, network traffic subsequently forwarded to the detector in association with the unique identifier may correspond to subsequent stages of a multi-stage attack that later yield a malicious verdict. In other words, a benign verdict can be indicative that there is not enough information to detect a multi-stage attack rather than the communications being truly benign.

At block 511, the detector indicates a malicious verdict to the cybersecurity appliance. The cybersecurity appliance can thus block the network traffic and prevent the next stage of the multi-stage attack from being carried out.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

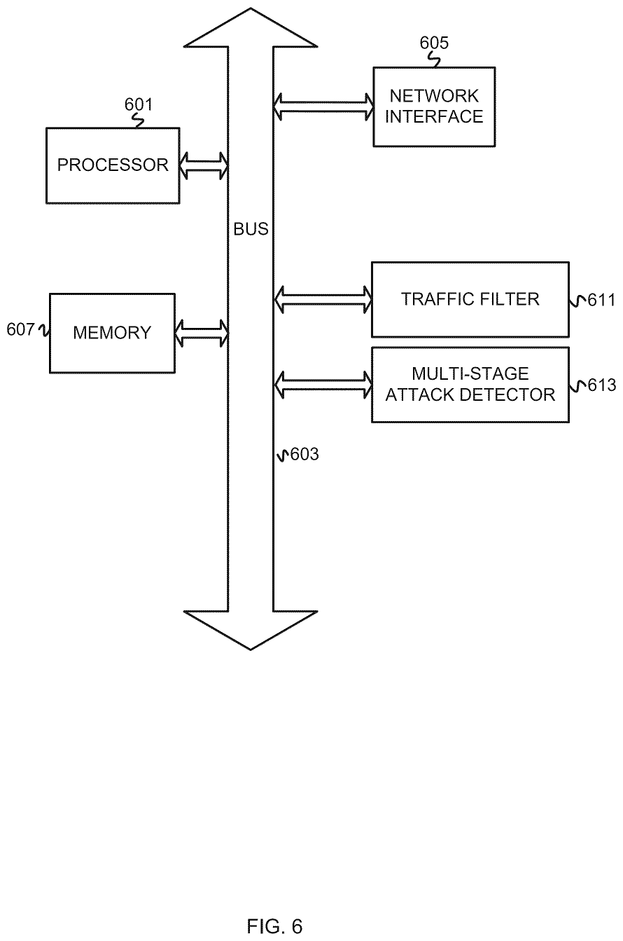

FIG. 6 depicts an example computer system with a traffic filter and a multi-stage attack detector. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes traffic filter 611 and multi-stage attack detector 613. The traffic filter 611 filters detected network traffic to be evaluated further for detection of potential multi-stage attacks. The multi-stage attack detector 613 correlates detected network traffic that is related, or network traffic that likely corresponds to multiple stages of communication, and evaluates the correlated network traffic for the presence of multi-stage attacks. While depicted as part of the same computer system in FIG. 6 to aid in understanding, the traffic filter 611 and multi-stage attack detector 613 do not necessarily execute as part of the same system. For instance, the traffic filter 611 can execute as a cybersecurity appliance, while the multi-stage attack detector 613 can execute as a cloud-based service with which the cybersecurity appliance communicates. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
based on obtaining first network traffic detected by a cybersecurity appliance, extracting first network traffic characteristics from the first network traffic and associating the extracted first network traffic characteristics with a unique identifier;
configuring a temporary forwarding rule for the cybersecurity appliance based on the extracted first network traffic characteristics, wherein the temporary forwarding rule comprises the unique identifier as metadata;
based on obtaining second network traffic in association with an indication of the unique identifier, extracting second network traffic characteristics from the second network traffic;
correlating the first network traffic characteristics and the second network traffic characteristics based on the unique identifier;
determining if the correlated first and second network traffic characteristics any of one or more rules for detecting multi-stage attacks; and
based on determining that the correlated first and second network traffic characteristics satisfy a first of the one or more rules for detecting multi-stage attacks, indicating a malicious verdict for the second network traffic.

2. The method of claim 1, further comprising blocking, by the cybersecurity appliance, the second network traffic based on obtaining the malicious verdict, wherein blocking the second network traffic blocks completion of a multi-stage attack.

3. The method of claim 1, wherein obtaining the first network traffic and the second network traffic is by a cloud-based service that communicates with the cybersecurity appliance.

4. The method of claim 3, further comprising forwarding, by the cybersecurity appliance, the first network traffic to the cloud-based service based on determining that the first network traffic satisfies a first of one or more filtering rules.

5. The method of claim 4, wherein the one or more filtering rules comprise one or more patterns, wherein determining that first network traffic satisfies a first of one or more filtering rules comprises determining that the first network traffic matches a first of the one or more patterns.

6. The method of claim 3, further comprising forwarding, by the cybersecurity appliance, the second network traffic and the indication of the unique identifier to the cloud-based service based on determining that the second network traffic satisfies the temporary forwarding rule.

7. The method of claim 1, wherein extracting the first network characteristics from the first network traffic comprises extracting the first network traffic characteristics from the first network traffic based on matching of the first network traffic to at least one of a first of one or more keywords and a first of one or more patterns defined for network traffic characteristics, wherein extracting the second network characteristics from the second network traffic comprises extracting the second network traffic characteristics from the second network traffic based on matching the second network traffic to at least one of a second of the one or more keywords and a second of the one or more patterns.

8. The method of claim 1, wherein correlating the first network traffic characteristics and the second network traffic characteristics based on the unique identifier comprises performing a lookup on maintained associations between unique identifiers and network traffic characteristics with the unique identifier, wherein a result of the lookup indicates the first network traffic characteristics.

9. The method of claim 1, wherein the one or more rules for detecting multi-stage attacks comprise one or more rules for detecting at least one of Server-Side Request Forgery (SSRF), Remote File Inclusion (RFI), command injection, and out-of-band Extensible Markup Language (XML) external entity attacks.

10. One or more non-transitory machine-readable media having program code stored thereon, the program code comprising instructions to:
extract at least one of first data and first metadata from first network traffic detected by a cybersecurity appliance and associate the extracted at least one of first data and first metadata with a unique identifier;
create a temporary forwarding rule for the cybersecurity appliance based on the extracted at least one of first data and first metadata, wherein the temporary forwarding rule comprises the unique identifier as metadata;
based on detection of second network traffic that matched the temporary forwarding rule, extract at least one of second data and second metadata from the second network traffic;
correlate the at least one of the first data and the first metadata with the at least one of the second data and the second metadata based on the unique identifier;
determine whether the correlated at least one of first data and first metadata and at least one of second data and second metadata satisfy any of one or more rules for detecting multi-stage attacks; and
based on a determination that the correlated at least one of first data and first metadata and at least one of second data and second metadata satisfy a first of the one or more rules for detecting multi-stage attacks, indicate a malicious verdict for the second network traffic.

11. The non-transitory machine-readable media of claim 10, wherein the program code further comprises instructions to block the second network traffic based on indication of the malicious verdict.

12. The non-transitory machine-readable media of claim 10,
wherein the instructions to extract at least one of the first data and the first metadata from the first network traffic comprise instructions to extract at least one of the first data and the first metadata from the first network traffic based on matching at least one of the first data and the first metadata to at least one of first of one or more keywords and a first of one or more patterns defined for network traffic characteristics,
wherein the instructions to extract at least one of the second data and the second metadata from the second network traffic comprise instructions to extract the at least one of the second data and the second metadata from the second network traffic based on matching at least one of the second data and the second metadata to at least one of a second of the one or more keywords and a second of the one or more patterns.

13. The non-transitory machine-readable media of claim 10, wherein the instructions to correlate the at least one of the first data and the first metadata with the at least one of the second data and the second metadata based on the unique identifier comprises performing a lookup on maintained associations between unique identifiers and at least one of data and metadata extracted from network traffic with the unique identifier, wherein a result of the lookup indicates the at least one of the first data and the first metadata.

14. A system comprising:
an apparatus comprising,
a first processor; and
a first machine-readable medium having instructions stored thereon that are executable by the first processor to cause the apparatus to,
based on detection of first network traffic, extract first network traffic characteristics from the first network traffic and associate the extracted first network traffic characteristics with a unique identifier;
create a temporary forwarding rule for a cybersecurity appliance based on the extracted first network traffic characteristics, wherein the temporary forwarding rule comprises the unique identifier as metadata;
based on detection of second network traffic in association with an indication of the unique identifier, extract second network traffic characteristics from the second network traffic;
correlate the first network traffic characteristics and the second network traffic characteristics based on the unique identifier;
determine if the correlated first and second network traffic characteristics any of one or more rules for detecting multi-stage attacks; and
based on a determination that the correlated first and second network traffic characteristics satisfy a first of the one or more rules for detecting multi-stage attacks, indicate a malicious verdict for the second network traffic.

15. The system of claim 14, further comprising the cybersecurity appliance, wherein the cybersecurity appliance comprises a second processor and a second machine-readable medium having instructions stored thereon that are executable by the second processor to cause the cybersecurity appliance to forward the first network traffic to the apparatus based on a determination that the first network traffic matches a first of one or more filtering rules.

16. The system of claim 15, wherein the one or more filtering rules comprise one or more patterns, wherein the instructions executable by the second processor to cause the cybersecurity appliance to determine that first network traffic matches a first of one or more filtering rules comprise instructions executable by the second processor to cause the cybersecurity appliance to determine that the first network traffic matches a first of the one or more patterns.

17. The system of claim 15, further comprising instructions executable by the second processor to cause the cybersecurity appliance to forward the second network traffic and the indication of the unique identifier to the apparatus based on a determination that the second network traffic matches the temporary forwarding rule.

18. The system of claim 15, further comprising instructions executable by the second processor to cause the cybersecurity appliance to block the second network traffic based on obtaining the malicious verdict, wherein the instructions executable by the first processor to cause the apparatus to indicate the malicious verdict comprise instructions executable by the first processor to cause the apparatus to communicate the malicious verdict to the cybersecurity appliance.

19. The system of claim 14,
wherein the instructions executable by the first processor to cause the apparatus to extract the first network characteristics from the first network traffic comprises instructions executable by the first processor to cause the apparatus to extract the first network traffic characteristics from the first network traffic based on matching of the first network traffic to at least one of first of one or more keywords and a first of one or more patterns defined for network traffic characteristics,
wherein the instructions executable by the first processor to cause the apparatus to extract the second network characteristics from the second network traffic comprise instructions executable by the first processor to cause the apparatus to extract the second network traffic characteristics from the second network traffic based on matching the second network traffic to at least one of a second of the one or more keywords and a second of the one or more patterns.

20. The system of claim 14, wherein the instructions executable by the first processor to cause the apparatus to correlate the first network traffic characteristics and the second network traffic characteristics based on the unique identifier comprise instructions executable by the first processor to cause the apparatus to perform a lookup on maintained associations between unique identifiers and network traffic characteristics with the unique identifier, wherein a result of the lookup indicates the first network traffic characteristics.
